(19) United States
(12) Patent Application Publication
(10) Pub. No.: US 2004/0139037 A1
(43) Pub. Date: Jul. 15, 2004

(54) Method for design of pricing schedules in utility contracts

(76) Inventor: Giuseppe Andrea Paleologo, Riverdale, NY (US)

Correspondence Address: WHITHAM, CURTIS & CHRISTOFFERSON, P.C., 11491 SUNSET HILLS ROAD, SUITE 340, RESTON, VA, 20190, US

(21) Appl. No.: 10/339,582

(22) Filed: Jan. 10, 2003

(51) Int. Cl. G06F 17/60

(52) U.S. Cl. 705/412; 705/1

(57) ABSTRACT

A provider of standardized services is provided with guidance on the design of pricing structures for contracts regulating the provision of a commodity good between a supplier and a customer. These are contracts characterized by long duration and dedicated infrastructure. The provision of the commodity good is variable over time, and the rate of provisioning is continuously monitored. Examples are kilowatt hours in the case of electric energy and megabytes/second in the case of Web hosting.

### BACKGROUND OF THE INVENTION

1. Field of the Invention

The present invention generally relates to the design of contracts for outsourced information services having similarities to contracts that are commonly adopted by suppliers of utility services and, more particularly, to the design of contracts for outsourced services provided by the information technology (IT) industry wherein customers are charged according to their actual resource usage during the term of the contract.

2. Background Description

Information services and utility services share one essential feature—the demand for such services varies over time. A Web hosting provider, a data storage facility, or a regional electric power provider offer contracts to corporate customers in which the provisioning of their service is allowed to vary during the contract interval. In these contracts, a central role is played by the pricing schedule, which determines the service charge based on the observed demand. Several considerations enter into the design of an effective pricing schedule. For example, the provider might take into account the differences in preferences among customers to design a nonlinear scheme that maximizes profits (R. B. Wilson, Nonlinear Pricing, Oxford University Press, NY, 1993). A consideration of a different nature is the risk faced by the provider. If the final charge is nearly independent of the usage, as in a fixed charge price, a customer with low demand might not find the contract attractive and walk away. On the other hand, if the charge is strongly dependent on the usage, the provider might not be able to recover its costs in the case of a customer with low demand. The pricing dilemma faced by the provider is linked to the costs the provider is incurring before the customer demand is observed.

Pricing for utility contracts has been explored by S. Oren, S. Smith and R. Wilson in “Capacity pricing”, Econometrica, 53(3):545-566 (1985), in the context of single-stage contracts. In their analysis, customers purchase in advance a consumption profile from a monopolist. J. Panzar and D. Sibley in “Public utility pricing under risk: the case of self-rationing”, The American Economic Review, 68(5):888-895 (1978), propose a two-stage setting. In their analysis, the customer purchases a peak rate in the first stage and is allowed to choose a consumption level during the second stage, provided that the consumption rate does not exceed the peak rate. The resulting equilibrium is not necessarily Pareto-optimal.

When considered as a newsvendor problem, the model can be interpreted as an optimal ordering problem in two stages, in which additional information is received before the second order. In this framework, the literature on channel coordination is vast and growing. M. Fisher and A. Raman in “Reducing the cost of uncertainty through accurate response to early sales”, Operations Research, 44(1):87-99 (1996), model the problem as a two stage production decision process, in which additional information for early sales is taken into account when setting production quantities in the second stage. G. D. Eppen and A. V. Iyer in “Backup agreements in fashion buying—the value of upstream flexibility”, Management Science, 43(11):1469-1484 (1997), also consider a two-stage setting, under different contractual agreements. L. Weatherford and P. Pfeifer in “The economic value of using advance booking of orders”, Omega, 22(1):405-411 (1994), analyze the informational advantage of advanced book-to-order in the case of normally distributed demands in stages one and two with known correlation. A. V. Iyer and M. E. Bergen in “Quick response in manufacturer-retailer channels”, Management Science, 43(4):559-570 (1997), study the benefits of multi-stage transactions between a retailer and a supplier, achieved via Bayesian updating of the supplier's beliefs. A taxonomy of scenarios in which the interested parties have asymmetric information is also presented by A. H.-L. Lau and H.-S. Lau in “Some two-echelon style-goods inventory models with asymmetric market information”, European J Oper. Res., 134:29-42 (2001), under specific demand assumptions.

The strategic analysis of centralized and decentralized behavior in inventory management is relatively recent. The articles of H. Lee and S. Whang, “Decentralized multi-echelon supply chains: Incentives and information”, Management Science, 45(5):633-640 (1999), and G. P. Cachon and P. H. Zipkin, “Competitive and cooperative inventory policies in a two-stage supply chain”, Management Science, 45(7):936-953 (1999), show how channel coordination may be achieved through a variety of mechanisms, such as linear transfer, and penalties rewards contingent on the observed demand. Finally, option mechanisms in inventory management have been proposed recently D. Shi, R. Daniels and W. Grey in “The Role of Options in Managing Supply Chain Risks”, IBM Research Report RC 21960 (2001).

Recently, the need for standardized information services has inspired the deployment of a new class of outsourcing services in the information technology (IT) industry. In these new offerings, customers are charged according to their actual resource usage during the contract duration, This represents a radical departure from past outsourcing contracts. The flexibility is desirable for the customer in a sector with high fixed costs, low marginal costs, and high depreciation rates for equipment.

Outsourcing contracts exhibit several distinctive features. First, the transactions are not directly generated by the customer, but by a large number of agents who have some relationship with him. For example, these agents can be the employees of a company, or the subscribers to an online service. This market structure has an important implication for the type of the contract—the arrival process of transactions is exogenous; i.e., its features are independent of the contractual obligations between customer and -provider. A second feature common to such contracts is that they are exclusive. The customer agrees to receive the service by only one provider for the contract duration. Finally, resale of the service is prohibited.

In the basic service setting, a customer signs a contract of fixed duration with the service provider. The contract specifies one or more service unit (SU). The SU is defined as a transaction of a certain type initiated by the customer and processed by the provider's service center. The SU depends on the context. For example, in the case of Web caching services, a possible unit would be a hypertext transfer protocol (http) GET request, while in the case of a managed storage service, the SU would be a megabyte (MB) of data transferred between customer and provider. The SU rate is continuously monitored by the provider. The final charge to the customer is contingent on the realization of the service rate curve. Within the framework outlined above, the pricing scheme adopted by the provider constitutes the core of the contract.

### SUMMARY OF THE INVENTION

It is therefore an object of the present invention to provide a solution to the pricing dilemma faced by the provider of information services.

According to the invention, “computing utilities” deliver processes running on a shared infrastructure, with standardized service metrics, and with prices that reflect the amount of service received. The initial capacity investment decision is critical to the success of a new offering. The problem of capacity allocation under a linear pricing contract resembles that of a newsvendor problem. A new pricing schedule is introduced in which, at the beginning of the contract, the customer can set a load threshold, below which the customer is charged a discounted unit price. If the customer has private information on his or her load characteristics, the invention attains full information revelation, and results in the highest possible utilitarian welfare for the system. The contract parameters can be computed based on the cost parameters of the problem, such as unit capacity costs and penalty costs. In addition, there is a family of price schedules that results in allocations for provider and customer that are a Pareto improvement over the standard schedule.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a block diagram of an exemplary system showing an information source provider connected through the Internet to a plurality of customers;

FIG. 2 is a graph showing the structure of a flexible discount contract;

FIG. 2A is a time line showing a sequence of events in the decision process;

FIG. 3 is a graph showing the expected allocating under the linear and flexible discount pricing;

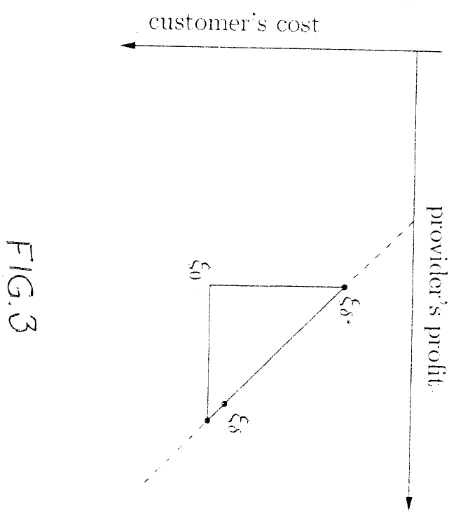

FIG. 4 is a graph showing welfare allocations under the linear and flexible discounts contracts;

FIG. 5 is a flowchart showing the basic process according to the invention;

FIG. 6 is a flowchart showing the logic of the monitoring process; and

FIG. 7 is a flowchart showing the logic of the computation process.

### DETAILED DESCRIPTION OF A PREFERRED EMBODIMENT OF THE INVENTION

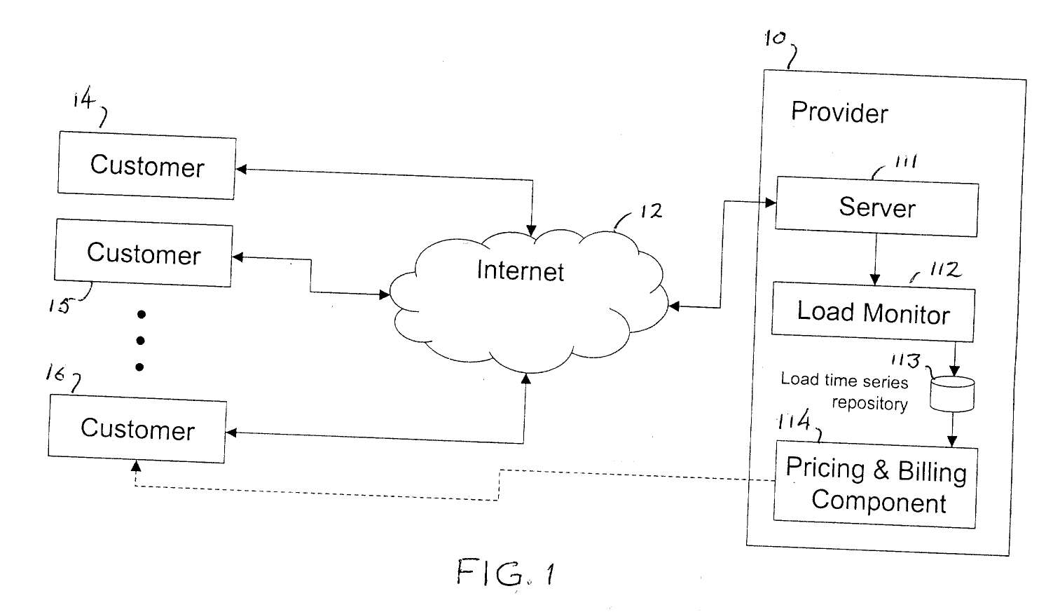

Referring now to the drawings, and more particularly to FIG. 1, there is shown a source provider 10 connected through the Internet 12 to a plurality of customers 14 to 16. The problem solved by this invention is the pricing of the services provided by the source provider 10 to the several customers 14 to 16. More specifically, the invention provides a pricing schedule in which, at the beginning of the contract, the customer can set a load threshold, below which he or she is charged a discounted unit price. The contract parameters can be computed based on such cost parameters as unit capacity and penalty costs.

The service provider 10 in the illustrated embodiment of FIG. 1 comprises a server 111 which is connected to the customers 14 to 16 through the Internet 12. The server 111 provides data to a load monitor 112 which monitors the loads of each of the individual customers 14 to 16. The monitored load time series as monitored by the load monitor 112 are stored in a repository 113. A pricing and billing component 114 of the service provider 10 accesses the load time series stored in the repository 113 and computes bills to each of the individual customers 14 to 16.

In the following description of the invention, a contract template which subsumes some contracts adopted in utility sectors, notably in the energy wholesaler/retailer and the IT outsourcing sectors, is analyzed. In this contract, the customer is charged based on the number of SU received by the customer during the contract duration. There are two objectives. First, there is provided a rationale for the existence of contracts that are popular among practitioners, but have received little attention among researchers. The contract is amenable to three interpretations. In the first, the contract can be viewed as a nonlinear pricing schedule in which the customer nominates the threshold for quantity discount. In the second, the contract is a bundle of options contingent on the observed customer load, in addition to “spot” contracts. In the third, the contract requires the customer to commit to a certain threshold, for which he pays ex ante, but gives him rebates for non-used capacity and SU above his committed capacity, but at a premium price. During the analysis, there is established a link between the flexible discount contract and the newsvendor model, that is often used in the supply-chain literature to model the relationship between the manufacturer of a perishable good and a retailer.

The second objective is to provide guidelines for the design of better contracts; i.e., contracts that achieve a higher social optimum and/or a higher rent for the provider. The provider can improve upon the basic usage-based contract by eliciting private information on the customer's demand profile. In particular, through a correct choice of the contracts parameters, the provider receives a rent that is arbitrarily close to the highest possible rent. The result does not make any assumption, neither on the probability distribution of demand nor on the probability distribution of customer profiles. When interpreted in the context of a newsvendor problem, the results show that, under the flexible discount contract, retailer and wholesaler achieve maximum channel coordination.

### Model Formulation

The contract time interval is divided into N sampling intervals of equal length. For each sampling interval n=1, . . . , N, the provider measures the number Xₙ, of Service Units (SU) provisioned to the customer. The cost structure of the provider is divided in long-run and short-run capacity costs. Before the starting date of the contract, the provider chooses his resource capacity q, where q is defined as the maximum number of SUs that can be served during a sampling interval. Let the unit cost of this capacity be c per sampling interval. If the demand during a sampling interval exceeds the capacity q, the provider can serve it by incurring a unit cost equal to c′, which is assumed to be strictly greater than c. This peak service is amenable to different interpretations. In some contexts, such as in electric power generation plants, the provider might own “spinning” generation units, which can provide short-run capacity, at higher marginal costs. In different contexts, such as Web hosting, idle servers might be dynamically reconfigured to serve the excess demand. Finally, if no physical capacity is available, c′ models the financial reimbursement paid by the provider in the case of denial of service, or might be a proxy for long-term losses due to reduced customer good will. If some units of the long-run capacity allocated to the provider are not used during a sampling interval, they can be salvaged during that interval, for example by diverting them for a different task. Let the salvage revenue be s per SU. We will use the shorthand mathematical notation x⁺=max{x,0}, xΛy=min{x,y}, and [symbol] {x≦y}=1 if x≦y, and 0 otherwise.

LINEAR PRICING: In the simplest form of a usage-based contract, the provider charges a unit price p per SU. It is assumed that the provider is a price-taker, so that p is not a decision variable. The profit of the provider is then equal to

$${V}_{N} = p {\sum }_{n = 1}^{N} {X}_{n} + s {\sum }_{n = 1}^{N} {( q - {X}_{n} )}^{+} - {c}^{′} {\sum }_{n = 1}^{N} {( {X}_{n} - q )}^{+} - Ncq \qquad ( 1 )$$

In addition to the contract introduced above, two-stage contracts are commonly used. In these contracts the customer selects a pricing schedule from a menu before the demand is observed (ex ante) and pays a fee that depends on the contract chosen. At the end of the contract interval the customer pays the provider a rent contingent on the observed demand and on the pricing schedule. Attention is concentrated on the following contract.

FLEXIBLE DISCOUNT: The customer reserves ex ante a discount threshold r, for which the customer pays a unit price Np₀. During a sampling interval the customer pays a discounted unit price p₁ if load does not exceed r, and pays the full price p if the load exceeds r. An alternative interpretation of the pricing schedule is the following: before the customer observes demand, the customer buys r call options at a price p that gives the customer the right to buy a SU at a unit price p, during each sampling interval. During each sampling interval the customer exercises his options. Another possible interpretation is of the contract is as committed capacity with rebates and penalties: before he observes demand, the customer buy a capacity r at unit price N(p₀+p₁). During each sampling interval, the customer receives a rebate equal to p₁ for each SU of his allotted capacity that has not been used, and pays an unit price p for each SU that the customer has used above the customer's allotted capacity. The final profit is then equal to

$${V}_{N} = {p}_{0} r + {p}_{1} {\sum }_{n = 1}^{N} {( {X}_{n} ⋀ r )}^{+} + p {\sum }_{n = 1}^{N} {( {X}_{n} - r )}^{+} + s {\sum }_{n = 1}^{N} {( q - {X}_{n} )}^{+} - {c}^{′} {\sum }_{n = 1}^{N} {( {X}_{n} - q )}^{+} - Ncq \qquad ( 2 )$$

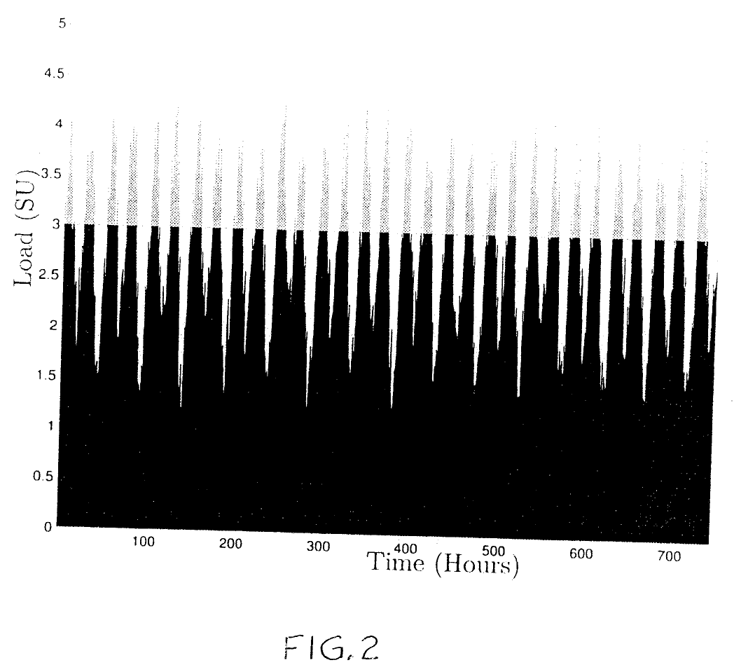

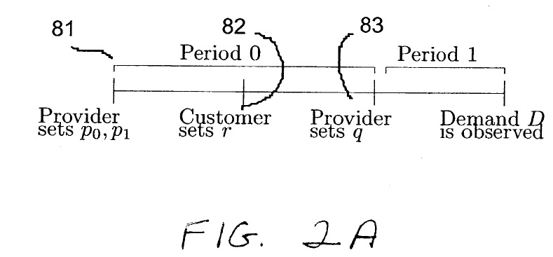

The flexible discount scheme is illustrated in FIG. 2.

Some remarks are in order. In this analysis, the unit price p is shared among pricing schedules. This is considered the reference price per SU. Also, it is noted that when the number of measurements N is large, the pricing formula can be approximated by a simpler, asymptotic expression. Let

$${\overline{V}}_{N} := \frac{{π}_{N}}{N} \text{and} {F}_{N} ( x ) = \frac{1}{N} {\sum }_{n = 1}^{N} 1 \{ {X}_{n} \leq x \} .$$

THEOREM 1: If the load process {Xₙ, n≧0} is stationary, integrable and ergodic, then the limits V=lim \overline{V}_{N}, and F(•) exist, and

V=p₀r+p₁E(DΛr)+pE(D−r)⁺+sE(q−D)⁺−c′E(D−q)⁺−cq (3)

where D is a rv with CDF equal to F(•).

PROOF OF THEOREM 1: Birkhoff's ergodic theorem (R. Durrett, Probability: theory and examples, Duxbury Press, Belmont, Calif., 2^{nd} Ed., 1996) states that, for any measurable function h(•), we have lim

$${N}^{- 1} {\sum }_{n = 1}^{N} f ( {X}_{n} ) = E [ h ( X ) ] ,$$

where X is a random variable with cumulative distribution function given by

$$F ( x ) = {N}^{- 1} {\sum }_{n = 1}^{N} 1 \{ {X}_{n} \leq x \} .$$

Applying this result to each element of the right hand side of Equation (1) the result follows.

If restricted to the linear pricing contract, Formula (3) becomes

V=pE(D−r)⁺+sE(q−D)⁺−c′E(D−q)⁺−cq.

The above formula bears a close resemblance with the newsvendor model. In the folk version of the problem, a wholesaler commits to satisfy the demand for a certain product of a retailer, and must decide in advance which quantity to order before the retailer's demand is observed. After the ordering decision is made, demand is revealed. If demand is lower than supply, the unsold product can be salvaged. On the other hand, if the wholesaler receives an order from the retailer that exceeds his available supply, he meets the demand by purchasing additional product at a premium price. In this notation, D represents the random demand of a product; q is the wholesaler's advance order at cost c; unit price paid by the retailer is p; unit salvage revenue is s; while cost for late orders is c′. It is assumed that c′>p>c>s. The newsvendor model and its variants have been used to model inventory decision problems in which the product has a short lifetime. The profit can be expressed as

πr(q, D)=pD+s(q−D)⁺−c′(D−q)⁺−cq.

The optimization problem has a unique solution

$$\hat{q} = {F}_{D}^{- 1} ( \frac{{c}^{′} - c}{{c}^{′} - s} ) .$$

The value

$$\hat{f} = \frac{{c}^{′} - c}{{c}^{′} - s}$$

is called the critical fractile.

### The Role of Commitment in Outsourcing Contracts

In order to increase expected profit, the provider can attempt to gain additional information on the customer's demand distribution. To make this statement precise, let us assume that the customer has a type θεΘ; the type is a vector that captures the heterogeneity of the customer population, and takes values in a subset of a euclidean space. The type contains the sufficient statistics of customer's demand Xn. For example, consider the case where the Xn are independent, identically distributed normal random variables. The type would be theta=(mu, sigma), i.e., the mean and standard deviation associated to the normal distribution. As a consequence, the type determines the statistical properties of the customer demand; i.e., the cumulative distribution function of demand for a customer of type θ can be written as F_{D|θ}(X|θ). We assume that the functional form of F_{D|θ}(•|•) is known to both provider and customer, and, for the sake of simplicity, we shall assume that for each θε|Θ, F_{D|θ}(•) be a continuous function. The customer has knowledge of his own type, while the provider has a prior probability measure P_{θ}on Θ for the customer type.

Under the linear pricing contract, the provider's optimal expected profit is given by

$$\begin{matrix}{V}_{1} = {max}_{q} E ( π ( q , D ) ) \\ = {max}_{q} ( Π ( q , θ ) )\end{matrix} \qquad ( 5 )$$

where II(q, θ)=E(π(q, D)|θ), the expected profit when produced quantity is q and customer's type is θ. Suppose that some additional information F the distribution of types is available to the provider before he or she has to decide q. Intuitively, F is the knowledge that θ belongs to a subset of Θ. The optimal expected profit conditional on F becomes

$$E ( {max}_{q} E ( Π ( q , θ ) \vert ℱ ) ) q .$$

Let h(π, F) be the value of information (VOI) associated to F, defined as the difference between optimal profit in the presence of information F and optimal profit without additional information.

$$\begin{matrix}h ( π , ℱ ) = E ( {max}_{q} Π ( q , θ ) \vert ℱ ) ) - {max}_{q} E ( Π ( q , θ ) ) \\ = E ( {max}_{q} E ( Π ( q , θ ) \vert ℱ ) ) - {max}_{q} E ( Π ( q , θ ) \vert ℱ ) ) .\end{matrix}$$

It is a well-known result that h(π, F) is nonnegative (see M. Avriel and A. Williams, “The value of information and stochastic programming”, Operations Research, 18(5):947-954, 1970). The VOI is maximized when the type of the customer is known exactly (I. H. La Valle, “On cash equivalents and information evaluation in decisions under uncertainty: Part I: Basic Theory”, Journal of the American Statistical Association, 63(321):252-276 1968). For all F,

$$\begin{matrix}E ( {max}_{q} ( Π ( q , θ ) \vert ℱ ) ) \leq E ( {max}_{q} E ( π ( q , D ) \vert θ ) ) \\ = E ( {max}_{q} Π ( q , θ ) ) \\ = E ( Π ( \hat{q} ( θ ) , θ ) ) \\ = {V}_{FB} ,\end{matrix} \qquad ( 6 )$$

where V_{FB} is the first-best solution and

\hat{q}(θ)=F_{D|θ}⁻¹(\hat{f}) (7)

is the optimal solution of the standard newsvendor problem when the type is known.

Based on the above observation, it is desirable for the provider to obtain additional information on the customer's type in order to increase the expected profit. There are several ways to obtain additional information about the customer's type. For example, interviews, market surveys and information contained in historical data of the customer's demand can provide useful information about his cumulative distribution function. There are several drawbacks to following this approach. The first one is that market research is expensive and time-consuming. Moreover, the information contained in such research might be unreliable. As an alternative, the provider can attempt to elicit information within the terms and communication channels established by the contract. The rationale behind our formulation of two-stage contracts is that the first stage serves a device to elicit the information relative to the customer's type that is relevant for capacity planning. Consider the flexible discount contract. The sequence of events is illustrated in FIG. 2A. In the first stage 81 of the decision process, the provider chooses parameters p₀,p₁ and offers the contracts. In the second stage 82 of the decision process, the customer chooses the number of contracts r. In the third stage 83, the provider sets the production level q using the available information. It is assumed that both provider and customer are risk-neutral, and that they maximize the net present value of their monetary transfers. For simplicity, the interest rate is set to zero. The main result can be formally stated as follows.

THEOREM 2: For any ε>0, let

p₁ε(p−ε/E(\hat{q}(θ)), p) (8)

$${p}_{0} = \frac{c - s}{{c}^{′} - s} ( p - {p}_{1} ) . \qquad ( 9 )$$

Then, the provider expected profit V(p₀,p₁) is such that

Vε(V_{FB}−ε, V_{FB}).

Furthermore, the optimal production level q* is given by r*, the number of contracts purchased by the customer in the second stage, and is independent of the choice of p₁, as long as p₀ satisfies Equation (9).

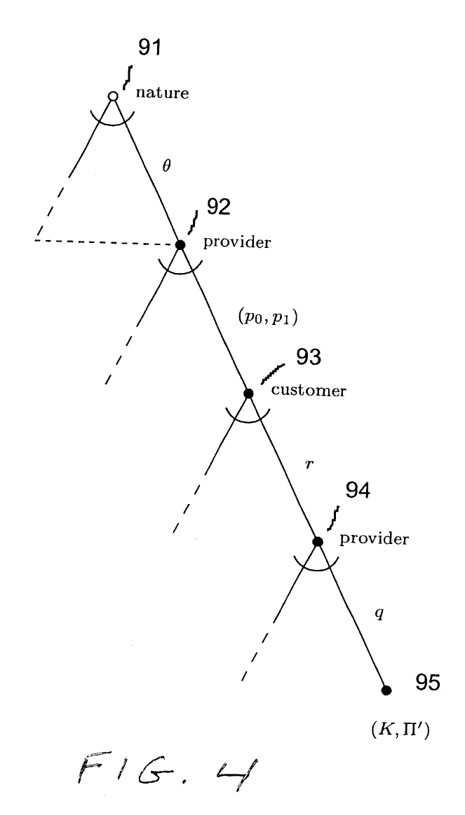

PROOF OF THEOREM 2: The contract can be formulated as a sequential game in five stages, as shown in FIG. 4. In the first stage 91, Nature chooses the customer's type according to a probability measure P_{θ} defined on the space Θ, which we assume to be the subset of a Euclidean space. In the second stage 92, the provider choose the values of p₀, p₁. In the third stage 93, the customer chooses the number of committed units r that minimize his expected cost. In the fourth stage 94, the provider chooses a production quantity q that maximize his expected profit, based on the available information. In the final stage 95, Nature chooses the state of the world W from a space Q. Demand is a function of both the observed state of the world and the customer's type, and we write D(ω,θ). We can express the provider's profit π′(p₀, p₁, r, q, ω,ψ) as follows:

$$\begin{matrix}\begin{matrix}{π}^{′} = {p}_{0} r + {p}_{1} ( D ( ω , θ ) ⋀ r ) + p ( D ( ω , θ ) - r ) + \\ {s ( q - D ( ω , θ ) )}^{+} - cq - {{c}^{′} ( D ( ω , θ ) - q )}^{+} \\ = {p}_{0} r + ( {p}_{1} - p ) D ( ω , θ ) ⋀ r ) + pD ( ω , θ ) + \\ {s ( q - D ( ω , θ ) )}^{+} - {{c}^{′} ( D - q ( ω , θ ) )}^{+} - \\ c ( q ( ω , θ ) )\end{matrix} & ( 10 ) \\ = {p}_{0} r + ( {p}_{1} - p ) ( D ( ω , θ ) ⋀ r ) + π ( q , D ( ω , θ ) ) & ( 11 )\end{matrix}$$

where π(q, D) is defined in Equation (4). The cost incurred by the customer is given by

$$\begin{matrix}κ ( p0 , p1 , r , ω , θ ) = {p}_{0} r + {p}_{1} ( D ( ω , θ ) ⋀ r ) + {p ( D ( ω , θ ) - r )}^{+} \\ = {p}_{0} r + ( {p}_{1} - p ) ( D ( ω , θ ) ⋀ r ) + p D ( ω , θ ) )\end{matrix} \qquad ( 12 )$$

The last stage of the game is a lottery with expected payoffs equal to

II(p₀, p₁, r, q, θ)=E(π′(p₀)p₁, r, q, ω, θ)|θ)

K(p₀, p₁, r, θ)=E(κ(p₀, p₁, r, ω, θ)|θ)

The game can be therefore reduced to a four-stage game, whose extensive form representation is shown in FIG. 4.

The concept of Weak Perfect Bayesian Equilibrium (A. Mas-Colell, M. D. Whinston and J. R. Green, Microeconomic Theory, Oxford University Press, 1995) is employed to determine the equilibrium strategies of this game. This is equivalent to finding beliefs on the customer's type that are consistent; i.e., that are derived using Bayes' rule whenever possible and to finding strategies for both the provider and the customer that are sequentially rational given the set of beliefs. In the context of this specific game, these requirements take a simple form. Consider the subgame comprised by stages three and four in FIG. 4. A type-θ customer's equilibrium strategy is described by a probability distribution P_{c}(r, θ) on the capacity commitment r. After the provider observes the commitment r, the provider's equilibrium strategy is described by a probability distribution Pₚ(q, r) on the capacity reservation q. The customer chooses a capacity r with positive probability only if this value minimizes the expected cost, based on the provider's strategy:

$$r ∈ arg {min}_{r} \int K ( {p}_{0} , {p}_{1} , r , θ ) ⅆ {P}_{p} ( q , r ) \qquad ( 14 )$$

Similarly, q is in the support of Pₚ(•, r) only if this value maximizes the expected profit, based on the customer's strategy:

$$q ∈ arg {max}_{q} \int {Π}^{′} ( {p}_{0} , {p}_{1} , r , q , θ ) ⅆ {F}_{θ \vert r} ( θ ) \qquad ( 15 )$$

where the provider updates his beliefs of the distribution of θ according to Bayes' rule:

$${dF}_{θ \vert r} ( θ ) = \frac{{f}_{c} ( r , θ ) {dF}_{θ} ( θ )}{\int {f}_{c} ( r , θ ) {dF}_{θ} ( θ )}$$

where f_{c}(•, θ) is the probability density associated to P_{c}(•, θ). The customer's cost is independent of the quantity q chosen by the provider in stage 4, so that Equation (14) becomes

$$r ∈ arg {min}_{r} K ( {p}_{0} , {p}_{1} , r , θ )$$

It can be readily seen that this is a newsvendor-like problem and that the optimal quantity r* of options is a solution of the equation

$${r}^{*} = {F}_{D \vert θ}^{- 1} ( 1 + \frac{{p}_{0}}{{p}_{1} - p} \vert θ ) \qquad ( 16 )$$

Therefore, the customer has a unique, pure equilibrium strategy r* (p₀, p₁, θ) given by Equation (16); r* is independent on the provider's choice of q in the following stage of the game. To compute the provider's equilibrium strategy, we rewrite Equation (15). The provider observes r*, and maximizes his or her expected profit conditionally on the information that θ is in the set

$${T}_{{r}^{*}} = \{ θ ∈ Θ \vert arg {min}_{r} K ( {p}_{0} , {p}_{1} , r , θ ) = {r}^{*} \} \qquad ( 17 )$$

And the provider's optimal reply is a pure strategy q* given by

$$arg {max}_{r} E ( {p}_{0} {r}^{*} + ( {p}_{1} - p ) ( D ⋀ {r}^{*} ) + Π ( q , θ \vert {T}_{{r}^{*}} ) ,$$

or, equivalently,

$$arg {max}_{q} E ( Π ( q , θ ) \vert {T}_{{r}^{*}} ) .$$

Having found the optimal strategy of the subgame, we use Equation (22), below, to determine the optimal pricing strategy (p₀, p₁) of the provider in stage 2.

$$V = {max}_{{p}_{0} , {p}_{1}} E [ {p}_{0} ( {r}^{*} ) + ( {p}_{1} - p ) ( D ⋀ {r}^{*} ) + E ( Π ( {q}^{*} , θ ) \vert {T}_{{r}^{*}} ) ] \qquad ( 18 )$$

We notice that the inequalities

$$\begin{matrix}E ( {p}_{0} {r}^{*} + ( {p}_{1} - p ) ( D ⋀ {r}^{*} ) ) \leq 0 & ( 19 ) \\ E ( E ( Π ( {q}^{*} , θ ) \vert {T}_{{r}^{*}} ) ) \leq E ( {max}_{q} Π ( q , θ ) ) & ( 20 )\end{matrix}$$

hold for all p₀, p₁. With regards to the former inequality, we use the inequality t,0185

Using Equations (23), below, and (10), above, we have

E(p₀r*+(p₁−p)(DΛr*)+pE(D))≦pE(D)

and the result follows. Inequality (20) follows from

$$E ( E \prod ( {q}^{*} , θ ) \vert {T}_{{r}^{*}} ) ) = E ( {max}_{q} E ( \prod ( q , θ ) \vert {T}_{{r}^{*}} ) ) \leq E ( {max}_{q} \prod ( q , θ ) ) ,$$

where the last inequality is Equation (6). The previous inequalities yield an immediate upper bound for the maximum expected payoff of the provider (Equation (18)):

$$V \leq E ( {max}_{q} E ( \prod ( q , θ ) ) = {V}_{FB} .$$

We now show that this a payoff arbitrarily close to this upper bound is actually attained under the assumptions of the theorem.

LEMMA 4: If p₀ satisfies Equation (9) then

1. The pure equilibrium strategy of the provider is given by

q*(r* (θ))=r*.

2. Equation (23) holds as an equality.

PROOF: The optimal strategy is given by

$$\begin{matrix}{q}^{*} ( {p}_{0} , {p}_{1} , {r}^{*} ) = arg {max }_{q} E ( \prod ( {p}_{0} , {p}_{1} , q , θ ) \vert {T}_{{r}^{*}} ) \\ = arg {max}_{q} ( s - c ) q - ( {c}^{′} - s ) E ( D ⩓ q \vert {T}_{{r}^{*}} )\end{matrix}$$

by substituting p₀ from Equation (20), we obtain

$$\begin{matrix}arg {max}_{q} ( s - c ) q - ( {c}^{′} - s ) E ( D ⩓ q \vert {T}_{{r}^{*}} ) = arg {min}_{r} {p}_{0} r + \\ ( {p}_{1} - p ) E ( D ⩓ r \vert {T}_{{r}^{*}} ) \\ = arg {min}_{r} E ( K ( {p}_{0} , {p}_{1} , r , θ ) \vert {T}_{{r}^{*}} )\end{matrix}$$

By Equation (17) we have

$${r}^{*} ( {p}_{0} , {p}_{1} , θ ) = arg {min}_{r} K ( {p}_{0} , {p}_{1} , r , θ ) ,$$

for all θ ε T_{r*}, from which we have

$$arg {min}_{r} E ( K ( {p}_{0} , {p}_{1} , r , θ ) \vert {T}_{{r}^{*}} ) = {r}^{*} .$$

Given the value r* from the customer, the provider knows that θ ε T_{r*}. The probability distribution dF_{θ|r*}. is supported by the set T_{r*}; i.e., P_{θ|r*}(T_{r*})=1. It follows that

$$\begin{matrix}{V}_{FB} = E ( {max}_{q} \prod ( q , θ ) ) \\ = E ( E ( {max}_{q} \prod ( q , θ ) \vert {T}_{{r}^{*}} ) ) \\ = E ( {max}_{q} E ( \prod ( q , θ ) \vert {T}_{{r}^{*}} ) ) .\end{matrix}$$

The last equality follows from the observation that

$${max}_{q} \prod ( q , θ ) = \prod ( {r}^{*} , θ )$$

for all θ ε T_{r*}.

LEMMA 5: If p₀, p₁ satisfy Equations (8), (9), we have

|E(p₀r*+(p₁−p)(DΛr*))|<ε.

PROOF: We first observe that, from Equations (7),(17), we have r*(p₀, p₁, θ)=\hat{q}(θ). Choose p₀, p₁ such that

$$0 < p - p1 < \frac{ε}{E ( \hat{q} ( θ ) )} .$$

We have

$$\vert E ( {p}_{0} , {r}^{*} + ( {p}_{1} - p ) ( D ⩓ {r}^{*} ) ) \vert = ( p - {p}_{1} ) \vert E ( \frac{c - s}{{c}^{′} - s} {r}^{*} - D ⩓ {r}^{*} ) \vert < ( p - {p}_{1} ) E ( \hat{q} ( θ ) ) < ε$$

From application of the previous lemmas to Equation (18) the result of Theorem 2 follows.

The result states that, under the prescribed pricing scheme, the customer can attain an expected profit that is arbitrarily close from the maximum possible attainable profit.

There is an intuitive explanation for the above result. Seeing prices p₀, p₁, p, the customer chooses a capacity r that minimizes his or her expected cost. The problem the customer faces is

$${min}_{r} {p}_{0} r + {p}_{1} E ( D ⩓ r ) + {pE ( D - r )}^{+}$$

It can be readily seen that this is a news vendor-like problem and that the optimal quantity r* of options is such that

P₀+(p₁−p)(1−F_{D|θ}(r*|θ))=0

or, after substitution of (p₀ using Equation (9),

s−c+(c′−s)(1−F_{D|θ}(r*|θ))=0

Therefore, r* is equal to the optimal capacity that the provider would choose in a linear pricing contract if the provider knew the type θ of the customer.

Another prescription of Theorem 2 is that the optimal initial capacity investment should be equal to the discount threshold r* purchased by the customer. This is a consequence of the particular choice of the parameters p₀, p₁. For arbitrary price parameters, the optimal capacity investment is in general different than r*.

A closely related result states that the new schedule can be used to obtain expected allocations that are Pareto-superior compared to the original pricing.

COROLLARY 3: Let V₁ be the provider expected profit defined in Equation (5), and let C₁=V₁ be the customer expected cost in the basic contract. Let

$${p}_{1} ∈ ( 0 , p ) , {p}_{0} \frac{c - s}{{c}^{′} - s} ( p - {p}_{1} ) ,$$

and let V(p₀, p₁), C(p₀, p₁) the expected profit (cost) of the provider (customer) under the flexible discount contract.

1. The utilitarian welfare of the provider and customer is equal to

V((p₀, p₁)−C(p₀, p₁))=V_{FB}−pE(D).

2. The expected customer's cost is linearly increasing as a function of

3.

$$Let {δ}^{*} = \frac{{V}_{FB} - {V}_{1}}{E ( D ⩓ \hat{q} ( θ ) + ( 1 - \hat{f} ) \hat{q} ( θ ) )} . If {p}_{1} > p - {δ}^{*} \qquad ( 21 )$$

the resulting allocation is Pareto improving upon the original allocation:

V(p₀, p₁)>V₁

C(p₀, p₁)<C₁

FIG. 4 shows the expected allocations under the linear and flexible discount pricing. The allocation ξ₀=(V₁, pE(D)) corresponds to the linear pricing contract. Under the flexible discount contract, a continuum of allocations can be achieved within the contract, i.e., without the need of ex post monetary transfer. If the contract parameters are parameterized

δε(0, (V_{FB}−V₁)(E(DΛ\hat{q}(θ)+(1−\hat{f})\hat{q}(θ)))⁻¹

p₁=p−δ

p₀=(1−\hat{f})δ

then the set of Pareto-improving allocation is given by the following curve:

ξ_{δ}=(V_{FB}(1−δ)+V₁δ), pE(D)−(V_{FB}−V₁)δ)

### The Case of Normal Demand

The result is illustrated in the important special case of normal demand. The customer type is given by the pair θ=(μ, σ), and written μ(θ), σ(θ). The customer has a prior distribution P on Θ.

Under perfect knowledge of the customer's type, the optimal capacity investment is expressed by Equation (7):

\hat{q}(θ)=μ(θ)+σ(θ)Φ−1(\hat{f}),

where (Φ(•) is the cumulative distribution function a standard normal random variable.

To compute the expected profit under perfect knowledge, we define a, b as follows:

$$\begin{matrix}a = p - c \\ b = ( {c}^{′} - s ) {\int }_{{Φ}^{- 1} ( \hat{f} )}^{∞} x ⅆ Φ ( x )\end{matrix}$$

Note that both a and b are positive.

$$\begin{matrix}E ( D ⩓ \hat{q} ( θ ) ) = {\int }_{- ∞}^{{Φ}^{- 1} ( \hat{f} )} ( μ ( θ ) + σ ( θ ) x ) ⅆ Φ ) ( x ) + \\ ( μ ( θ ) + σ ( θ ) {Φ}^{- 1} ( \hat{f} ) ) ( 1 - \hat{f} ) \\ = μ ( θ ) + σ ( θ ) ( {Φ}^{- 1} ( \hat{f} ) - {\int }_{{Φ}^{- 1} ( \hat{f} )}^{∞} x ⅆ Φ ( x ) )\end{matrix}$$

Applying this formula we get

$$\begin{matrix}\begin{matrix}{max}_{q} E ( π ( q , D ) \vert θ ) = pE ( D ) - c \hat{q} - {c}^{′} {E ( D - \hat{q} ( θ ) )}^{+} + \\ {sE ( \hat{q} ( θ ) - D )}^{+} \\ = ( s - c ) \hat{q} ( θ ) + ( {c}^{′} - s ) E ( D ⩓ \hat{q} ( θ ) ) - \\ ( {c}^{′} - p ) E ( D ) \\ = a μ ( θ ) - b σ ( θ )\end{matrix} & ( 22 ) \\ \begin{matrix}Since {V}_{FB} = E ( {max}_{q} E ( π ( q , D ) \vert θ ) ) , we have \\ VFB = aE ( μ ) - bE ( σ )\end{matrix} & ( 23 )\end{matrix}$$

Moreover, the value of V₁ can be computed by noticing that the distribution of D in the absence of information on types is still normally distributed, with mean equal to Eμ(θ) and standard deviation equal to (Eσ²(θ))^{1/2}. From Equation (12) we immediately obtain

V₁=aE(μ)−b(Eσ²)^{1/2}.

The value of information in the case of normally distributed demand admits a simple formula, which is independent on the prior distribution on the mean, but depends on the first two moments of the standard deviation with respect to the prior measure P on the customers'types.

V_{FB}−V₁=b((E((σ²))^{1/2}−E(σ)).

Let us define

$$d = ( 2 + \hat{f} ) E ( μ ) + ( 2 ( 1 + \hat{f} ) {Φ}^{- 1} ) ( \hat{f} ) - {\int }_{{Φ}^{- 1} ( \hat{f} )}^{∞} x ⅆ Φ ( x ) ) E ( σ ) .$$

The lower bound for Pareto-improving prices p, is given by

$$p - \frac{{V}_{FB} - {V}_{1}}{E ( D ⩓ \hat{q} ( θ ) + ( + \hat{f} ) \hat{q} ( θ ) )} = p - \frac{b}{d} ( {( E ( {σ}^{2} ) )}^{1 / 2} - E ( σ ) ) .$$

The properties of a class of contracts that are being increasingly adopted in the utility industry were investigated to determine the monetary transfers between a provider of the service and a customer. In these contracts, the provider faces an initial capacity investment decision in the face of uncertain demand. The contract enables the provider to obtain from the customer the information needed for optimal ex ante capacity planning. The resulting utilitarian welfare is first-best, and can be achieved for any users' type distribution and demand distribution function. Furthermore, the surplus can be allocated in any proportion among customer and provider without the need of out-of-contract monetary transfers.

The flexible discount contract described above bears a similarity to signaling models (M. Spence, “Job market signaling”, The Quarterly Journal of Economics, 87(3):355-374, 1973) and to models of preplay communication, or “cheap talk”(V. P. Crawford and J. Sobel, “Stategic information transmission”, Econometrica, 50(6):1431-1451, 1982). To make the connection clear, the last two stages of the contract are considered, in which the customer first chooses a threshold level and then the provider makes a capacity planning decision. In this subgame, the informed party (the customer) moves first, and his or her action reveals information about his or her type to the uninformed party (the provider), who uses it when he or she has to provide for capacity. The provider does not obtain full disclosure of the customer's type; yet, the knowledge of the capacity threshold selected by the customer is sufficient to make an optimal capacity planning decision. This subgame is therefore similar to the standard signaling setting, in that the informed party moves first by sending a costly signal. On the other hand, it is similar to models of preplay communication, in that the payoff of the informed player is not a direct function of the player's type.

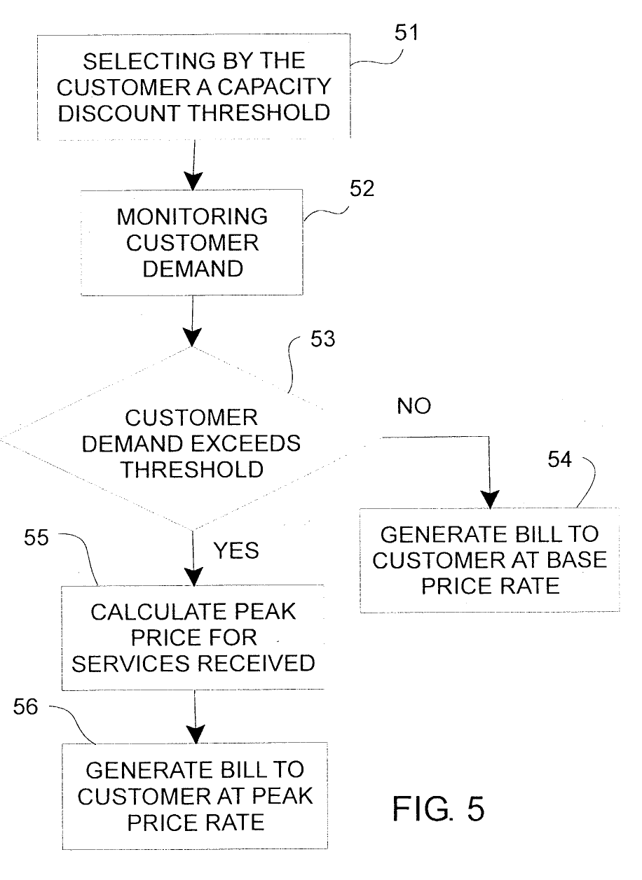

FIG. 5 is a flowchart showing the overall process according to the invention. The process begins in function block 51 where the customer selects a capacity discount threshold. During the providing of services units (SUs), the provider 10 monitors in function block 52 the load of the customer with the load monitor 112 (see FIG. 1). A determination is made in decision block 53 as to whether the customer demand exceeds the selected capacity discount threshold. If not, the pricing and billing component 114 (FIG. 1) generates a bill to the customer at the base price rate in function block 54. On the other hand, if the customer demand exceeds the selected capacity discount threshold, then the pricing and billing component 114 first calculates the peak price for the services received in function block 55 and then generates a bill to the customer at the peak price rate in function block 56.

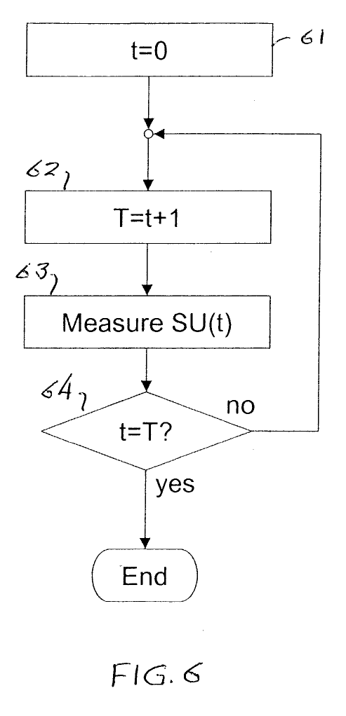

FIG. 6 is the flowchart of the monitoring process performed by the load monitor 112 (FIG. 1) in function block 52 (FIG. 5). Time t is initialized to zero in function block 61 at the beginning of the process. Then a processing loop is entered at the beginning of which the load time period T is incremented by one in function block 62. A measurement is made of SU(t) in function block 63. A determination is made in decision block 64 as to whether t=T and, if not, the process loops back to function block 62; otherwise, the measured load time series is stored in repository 113 (FIG. 1) before the process terminates.

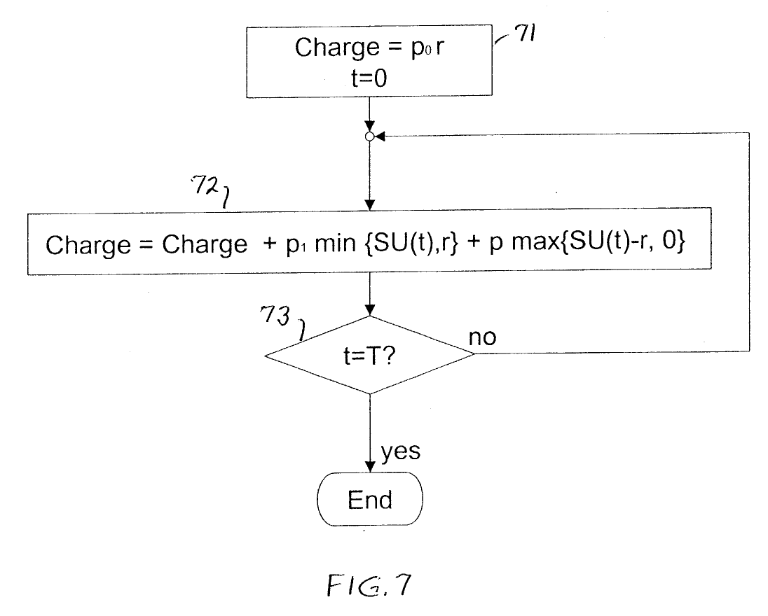

FIG. 7 is a flowchart of the computation process of the pricing and billing component 114 (FIG. 1) performed in function block 55 (FIG. 5). The process begins by initializing the Charge to p₀r and time t to zero in function block 71. The process then enters a processing loop which begins by computing the Charge as

Charge+p₁ min {SU(t), r}+p max {SU(t)−r, 0}

in function block 72. A determination is made in decision block 73 as to whether t=T and, if not, the process loops back to function block 72; otherwise, the bill is generated based on the computation and the process ends.

While the invention has been described in terms of a single preferred embodiment, those skilled in the art will recognize that the invention can be practiced with modification within the spirit and scope of the appended claims.

Having thus described my invention, what I claim as new and desire to secure by Letters Patent is as follows:

1. A method for design of pricing schedules in utility contracts comprising the steps of:
before a contract starting date, selecting by a customer a capacity discount threshold, said capacity discount threshold being a prespecified rate of provisioning by a provider of standardized services, a price paid by the customer to the provider for the standardized services being proportional to the selected threshold;
during a term of the contract, measuring by the provider demand by the customer of the standardized services; and
if demand rate by the customer of the standardized service stays below the selected threshold, paying by the customer a base price per unit of standardized services received, but if the instantaneous demand rate by the customer of standardized service exceeds the selected threshold, paying by the customer a peak price per unit of standardized services received, which peak price is greater than the base price.

2. The method of claim 1, wherein a contract interval is divided into N sampling intervals of equal length, for each sampling interval n=1, . . . ,N, the step of measuring by the provider measures a number Xₙ of service units (SUs) provided to a customer.

3. The method of claim 2, wherein before a starting date of a contract, choosing by the provider a resource capacity q, where q is defined as a maximum number of SUs that can be served during a sampling period, wherein a unit cost of the resource capacity q is c per sampling period, and wherein if demand during a sampling interval exceeds the resource capacity q, the provider can serve the demand by incurring a unit cost equal to c′ which is greater than c.

4. The method of claim 3, wherein the provider selects a positive parameter epsilon, with epsilon<p, and sets parameters p0=(c−s)/(c′−s)*epsilon and p1=p-epsilon, and wherein the step of selecting by a customer a capacity discount threshold the customer reserves ex ante a discount threshold r, for which the customer pays a unit price Np0, and wherein during a sampling interval, paying by the customer a discounted unit price P1, if load does not exceed r and paying by the customer a full price p if the load exceed r.

5. The method of claim 3, wherein the provider selects a positive parameter ε, with ε<p, and sets parameters p0=(c−s)/(c′−s)*ε and p1=p−ε, and wherein the step of selecting by a customer a capacity discount threshold the customer reserves ex ante a capacity r, for which the customer pays a unit price N(p0+p1), and wherein during a sampling interval, paying by the customer a discounted unity price p1, if load does not exceed r and paying by the customer a full price p if the load exceed r.

6. A system for facilitating the design of pricing schedules in utility contracts comprising:
a provider of standardized services to a plurality of customers wherein, before a contract starting date, each of the plurality of customers selects a capacity discount threshold, said capacity discount threshold being a prespecified rate of provisioning by the provider of standardized services, a price paid by the customer to the provider for the standardized services being proportional to the selected threshold, an allocated capacity by the provider equal to the sum of the capacity discount threshold selected by the customers;
a load monitor at the provider for monitoring, during terms of contracts with said plurality of customers, demands by each customer of said plurality of customers of the standardized services provided by the provider; and
a pricing and billing component at the provider and responsive to monitored demands by each customer of said plurality of customers to determine if demand rate by a customer of the standardized service stays below the threshold selected by the customer, and if so, billing the customer a base price per unit of standardized services received, but if the instantaneous demand rate by the customer of standardized service exceeds the threshold selected by the customer, billing the customer a peak price per unit of standardized services received, which peak price is greater than the base price.

7. The method of claim 4, wherein the provider selects a positive parameter ε, with ε<p, and sets parameters p0=(c−s)/(c′−s)*ε and p1=p−ε, and wherein the step of allocating by the provider a capacity q the provider allocates q, equal to the capacity threshold reserved ex ante by the customer.
